(19) United States
(12) Patent Application Publication
(10) Pub. No.: US 2025/0191422 A1
(43) Pub. Date: Jun. 12, 2025

(54) SENSOR-BASED AIR FILTRATION SYSTEM MANAGEMENT

(71) Applicant: AT&T Intellectual Property I, L.P., Atlanta, GA (US)

(72) Inventors: Barrett Kreiner, Woodstock, GA (US); Ryan Schaub, Berkeley Lake, GA (US)

(21) Appl. No.: 18/537,757

(22) Filed: Dec. 12, 2023

(51) Int. Cl. G07C 5/04; B60H 3/06; B60S 5/00; G07C 5/00

(52) U.S. Cl. CPC G07C 5/04; B60H 3/0616; B60S 5/00; G07C 5/008; B60H 2003/0683

(57) ABSTRACT

A processing system including at least one processor may obtain utilization data of an air filter in an air filtration system and environmental data for at least one location associated with the air filtration system. The processing system may then determine at least one filter changing action based upon at least the utilization data and the environmental data and transmit at least one instruction to implement the at least one filter changing action.

The present disclosure relates to network-connected devices (e.g., Internet of Things (IoT) devices), and more particularly to devices, non-transitory computer-readable media, and methods for transmitting an instruction to implement a filter changing action based upon air filter utilization data and environmental data.

### BRIEF DESCRIPTION OF THE DRAWINGS

The teaching of the present disclosure can be readily understood by considering the following detailed description in conjunction with the accompanying drawings, in which:

FIG. 1 illustrates an example network or system related to the present disclosure;

FIG. 2 illustrates a flowchart of an example method for transmitting an instruction to implement a filter changing action based upon air filter utilization data and environmental data; and

FIG. 3 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

Devices, computer-readable media, and methods for transmitting an instruction to implement a filter changing action based upon air filter utilization data and environmental data are disclosed. For example, a processing system including at least one processor may obtain utilization data of an air filter in an air filtration system and environmental data for at least one location associated with the air filtration system. The processing system may then determine at least one filter changing action based upon at least the utilization data and the environmental data and transmit at least one instruction to implement the at least one filter changing action.

To illustrate, examples of the present disclosure may include an air filter monitoring and maintenance system that may track the usage of an air filter via measurements of filter occupancy, airflow, time of use, and so forth, and that may further initiate filter changes based upon anticipated usage in accordance with environmental forecasts and/or a user schedule/calendar. For instance, in one example, a monitoring system of the present disclosure may obtain one or more environmental data feeds containing, for example: meteorological information including precipitation, temperature, pollen count/predominant source, etc., extenuating environmental issues (e.g., wildfires, sandstorms, volcanic eruptions, etc.), or the like. In one example, the monitoring system may be in communication with one or more smart home/Internet of things (IoT) appliances or components associated with an air filtration system, such as the air filtration system itself, a heating ventilation air conditioning (HVAC) system in which the air filtration system is a component, a thermostat, or the like to identify the time of service of the filter that was used, the air volume processed via the filter, and/or other measurements. In one example, the air filtration system (and the filter) may be components of a mobile system, e.g., a vehicle. In such an example, the monitoring system may be in communication with the vehicle to obtain filter usage information. In addition, in such an example, the monitoring system may further obtain vehicle location history, user calendar/scheduling information indicating travel dates and times, intended destination(s)/location(s), route(s), and so forth. In still another example, user calendar/scheduling data may also be accessed and used in connection with examples associated with fixed-location filter use (e.g., knowing when a user is expected to be home/not home, or present/not present at some other facility).

In one example, the air filtration system may include various sensors/modules for detecting different types of materials that may be trapped by an air filter, such as a spectrometry module, a fluorescent probing module, a lipopolysaccharide detection module, a particulate sensor, or a volatile organic compound sensor. Alternatively, or in addition, examples of the present disclosure may deploy an analysis system at a location (e.g., a home improvement store or the like), where a user may bring a used air filter for scanning/analysis. For instance, the analysis system may include various modules/sensors such as described above, which may process the air filter (e.g., sequentially or in parallel) to analyze contents captured by the air filter over time, such as chemicals, including volatile organic compounds (VOCs), 2.5 micron particulate, 10 micron particulate, biologics, e.g., bacteria, viruses, insects, etc., and so forth. In one example, one or more of the sensors/modules may consume at least a portion of the filter as part of the analysis/measurement. The result may be indications of the presence of one or more types of materials, a concentration of such materials, etc. In one example, the monitoring system may obtain such measurements from an air filtration system or external analysis system. In another example, the analysis system may be a component of the monitoring system.

Using any and all such information described above, the monitoring system may generate instructions regarding whether and when to replace the air filter. In one example, the instructions may further include instructions to change to a filter having a different filter rating (e.g., a higher/lower MERV (minimum efficiency rating value) factor, high-efficiency particulate absorbing filter (HEPA) to non-HEPA, or vice versa, and so forth). In one example, the monitoring system may provide coupons for replacement filters, may provide links to websites where recommended filter(s) is/are available for purchase, and/or may automatically order and schedule delivery of such filters, e.g., from one or more online merchant partners. Thus, for example, the monitoring system may proactively notify the time to replace the filter, including scheduling a filter changing timing based on environmental events, user and/or vehicle travel, prior utilization of the air filter, scheduled maintenance/repair of the air filtration system (e.g., HVAC, duct work, vehicle, etc.), and so forth.

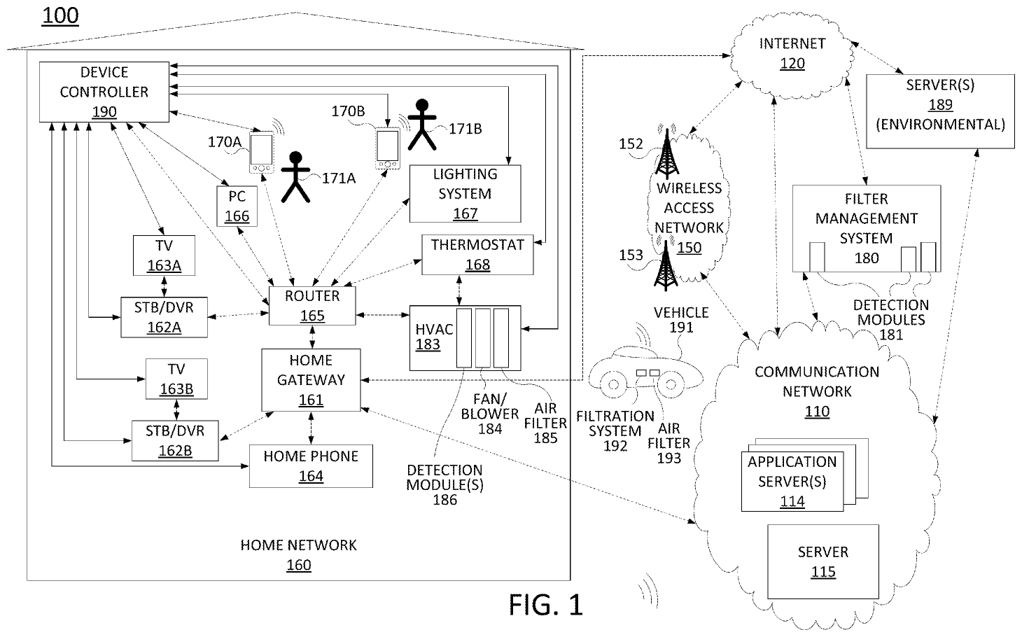

Thus, examples of the present disclosure provide proactive maintenance of protected environments including homes, offices, schools, businesses, and so forth, as well as vehicles or other mobile enclosed environments (such as trailers or the like). In particular, examples of the present disclosure obtain samples of the environment over relatively long periods of time, which may be used in conjunction with environmental forecasts from one or more external services to predict future environmental conditions. Combined with knowledge of filter state, and in one example, in further consideration of a user's and/or a vehicle's schedule, the present disclosure may then identify optimal times for filter replacement, allowing a user of a protected space to assess air quality conditions before larger issues arise. For example, this may be configurable by the conditions of the users/occupants of the area. For instance, conditions such as asthma, severe allergies, or the like may lead to different desired environmental settings as compared to other users. This is in contrast to prior reactive approaches where air filters may only be replaced after an air quality issue is detected by a user, such as by smell, visual inspection of a volume of materials trapped by a filter, sound of straining motor, etc. or where replacement is simply scheduled by a fixed duration of time since the installation of the current filter. In one example, the present disclosure may be integrated with or into other IoT, smart building, and/or smart vehicle systems. These and other aspects of the present disclosure are discussed in greater detail below in connection with the examples of FIGS. 1-3.

To aid in understanding the present disclosure, FIG. 1 illustrates an example system 100 in which examples of the present disclosure may be implemented. As shown in FIG. 1, the system 100 connects mobile devices 170A and 170B and home network devices such as home gateway 161, set-top boxes (STBs) 162A, and 162B, television (TV) 163A and TV 163B, home phone 164, router 165, personal computer (PC) 166, lighting system 167, thermostat 168, heating, ventilation, and air conditioning system (HVAC) 183, and so forth, with one another and with various other devices via a communication network 110, a wireless access network 150 (e.g., a cellular network), and Internet 120.

In one example, either or both of the mobile devices 170A and 170B may comprise a subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, either or both of the mobile devices 170A and 170B may have both cellular and non-cellular access capabilities and may further have wired communication and networking capabilities. In one example, mobile devices 170A and 170B may be used by users 171A and 171B, respectively, who may be associated with one another as family members, e.g., parents and children, as friends, as co-workers, as caregiver and charge(s), and so forth.

In one example, communication network 110 may combine core network components of a cellular network with components of a triple play service network; where triple-play services include telephone services, Internet services, and television services to subscribers. For example, communication network 110 may functionally comprise a fixed mobile convergence (FMC) network, e.g., an IP Multimedia Subsystem (IMS) network. In addition, communication network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication network 110 may also further comprise a broadcast television network, e.g., a traditional cable provider network or an Internet Protocol Television (IPTV) network, as well as an Internet Service Provider (ISP) network. For example, with respect to television service provider functions, application servers 114 may represent one or more television servers for the delivery of television content, e.g., a broadcast server, a cable head-end, and so forth. For instance, communication network 110 may comprise a video super hub office, a video hub office and/or a service office/central office. With respect to cellular core network functions, application servers 114 may represent a Home Subscriber Server/Home Location Register (HSS/HLR) for tracking cellular subscriber device location and other functions, a serving gateway (SGW), a packet data network gateway (PGW or PDN GW), a mobility management entity (MME), and so forth. Application servers 114 may further represent an IMS media server (MS) for handling and terminating media streams to provide services such as announcements, bridges, and Interactive Voice Response (IVR) messages for VoIP and cellular service applications. As shown in FIG. 1, communication network 110 may also include a server 115, described in greater detail below. For ease of illustration, various additional elements of communication network 110 are omitted from FIG. 1.

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G), or any other yet to be developed future wireless/cellular network technology. While the present disclosure is not limited to any particular type of wireless access network, in the illustrative embodiment, wireless access network 150 is shown as a UMTS terrestrial radio access network (UTRAN) subsystem. Thus, base stations 152 and 153 may each comprise a Node B or evolved Node B (eNodeB). As illustrated in FIG. 1, mobile devices 170A and 170B may be in communication with one or both of the base stations 152 and 153, which provide connectivity between the mobile devices 170A-170B and other endpoint devices within the system 100, various network-based devices, such as server 115, application servers 114, and so forth. In one example, wireless access network 150 may be operated by the same or a different service provider that is operating communication network 110.

In one example, home network 160 may include a home gateway 161, which receives data/communications associated with different types of media, e.g., television, phone, and Internet, and separates these communications for the appropriate devices. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 170A-170B, lighting system 167, thermostat 168, HVAC 183, and so forth. In one example, router 165 may further communicate with TV (broadly a display) 163A and/or 163B, e.g., where one or both of the televisions is a smart TV. In one example, router 165 may comprise a wired Ethernet router and/or an IEEE 802.11 (Wi-Fi) router, and may communicate with respective devices in home network 160 via wired and/or wireless connections. In this regard, it should be noted that lighting system 167, thermostat 168, and HVAC 183 may comprise “smart” appliances (e.g., network-connected devices/Internet of Things (IoT) devices), with wired and/or wireless networking/communication capability. Thus, such appliances may be remotely programmed or configured, and may communicate operational data to remote devices via one or more networks or network links. Similarly, TVs 163A and 163B, STBs/DVRs 162A and 162B, and/or home phone 164 may also comprise smart appliances with wired and/or wireless networking/communication capability, which may be remotely programmed or configured, and which may communicate operational data to remote devices via one or more networks or network links. For instance, each of these devices may include a transceiver, line card, or the like for wired and/or wireless communication, such as an infrared transmitter or transceiver, an Ethernet line card, a transceiver for Institute for Electrical and Electronics Engineers (IEEE) 802.11 based communications (e.g., “Wi-Fi”), IEEE 802.15 based communications (e.g., “Bluetooth”, “ZigBee”, etc.), and so forth.

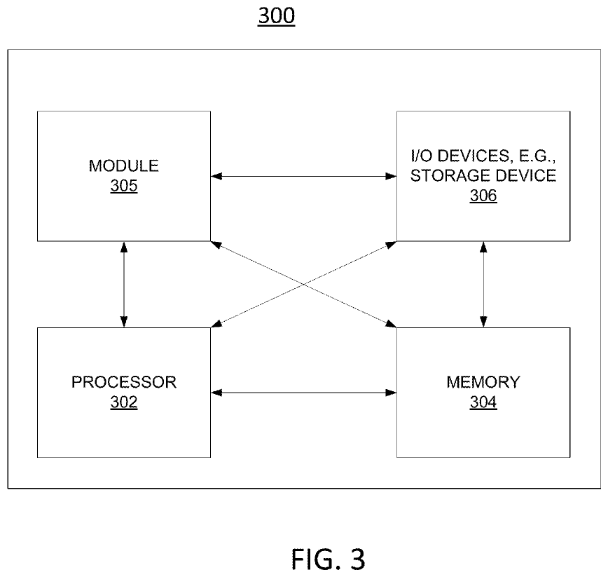

In one example, home network 160 may also include a device controller 190. In one example, the device controller 190 may comprise a computing system, such as computing system 300 depicted in FIG. 3, and may be configured to provide one or more functions in connection with examples of the present disclosure for transmitting an instruction to implement a filter changing action based upon air filter utilization data and environmental data. As illustrated in FIG. 1, device controller 190 may be in communication with various network-connected devices/appliances within home network 160. In this regard, device controller 190 may also include a transceiver for IEEE 802.11-based communications, for IEEE 802.15-based communications, for wired communications, e.g., for wired Ethernet, and so forth. It should be noted that as described herein, functions of device controller 190 may similarly be performed by server 115 in communication network 110, and vice versa.

As further illustrated in FIG. 1, the system 100 may include a filter management system 180. For instance, in the present example, filter management system 180 (or “monitoring system”) may include an analysis system, e.g., comprising one or more detection modules 181. In one example, the filter management system 180 may comprise a computing system, such as computing system 300 depicted in FIG. 3, and may be configured to provide one or more functions for transmitting an instruction to implement a filter changing action based upon air filter utilization data and environmental data, as described herein. For example, filter management system 180 may be configured to perform one or more steps, functions, or operations in connection with the example method 200 described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In accordance with the present disclosure, detection modules 181 may include a spectrometry module, a fluorescent probing module, a lipopolysaccharide detection module, a particulate sensor (e.g., laser scattering based or can be a thermal electrical sensor), or a volatile organic compound sensor, and so forth. In one example, the detection modules 181 may measure or capture data regarding various physical parameters of an air filter that may be inserted into the filter management system 180 (e.g., air filter utilization data/utilization data of an air filter), such as a coverage measure of materials trapped by the air filter, an identification of at least one material type of the materials trapped by the air filter, and so forth, depending upon the type of detection module(s). For instance, air filter 185 may be removed from HVAC 183 and brought to a location of the filter management system 180, e.g., a hardware store or the like.

Alternatively, or in addition, an air filtration system (e.g., HVAC 183) may include the same or similar detection modules. For instance, HVAC 183 may include various components, such as a fan/blower 184, a removable air filter 185, and one or more detection module(s) 186. In such an example, detection module(s) 186 may obtain coverage measures of materials trapped by the air filter, may identify at least one material type of the materials trapped by the air filter, and so forth. In addition, HVAC 183 may maintain utilization records of the fan/blower 184, e.g., to identify the times and/or duration of time that the air filter 185 has been in use, the volume of air that may be processed via HVAC 183 (and hence processed by air filter 185), and so forth. In one example, HVAC 183 may report such filter utilization data to filter management system 180, e.g., via wired communication via router 165 and home gateway 161, via wireless communication via wireless access network 150, or the like. Alternatively, or in addition, HVAC 183 may report such data to device controller 190, which may be configured to further forward such information to filter management system 180.

In one example, filter management system 180 may process the filter utilization data (e.g., obtained from HVAC 183 and/or from its own detection modules 181) to determine at least one filter changing action. In addition, filter management system 180 may then transmit at least one instruction to implement the at least one filter changing action. In one example, filter management system 180 may gather and utilize additional information in determining the at least one filter changing action. For instance, FIG. 1 further illustrates server(s) 189, which may comprise one or more environment data sources. To illustrate, server(s) 189 may comprise one or more weather data sources, e.g., including an air quality data source. For example, server(s) 189 may represent a weather data server (WDS). In one example, the weather data may be received via a weather service data feed, e.g., a National Weather Service (NWS) extensible markup language (XML) data feed, or the like. In another example, the environmental data may be obtained by retrieving the environmental data from a WDS, or the like. The environmental data may include wind speed and direction, 10 micron particulate matter (PM 10) concentration, 2.5 micron particulate matter (PM 2.5) concentration, smog concentration, and so forth. The environmental data may further include temperature, precipitation type and quantity, atmospheric pressure, and so forth. The environmental data may comprise one or both of the historical environmental data (e.g., including or in addition to current (e.g., most recently available) environmental data) or forecast environmental data, e.g., for the location of air filter 185 and/or the location of HVAC 183 in which air filter 185 is deployed. Alternatively, or in addition, server(s) 189 may include one or more environmental alert sources, such as a server of a governmental agency that provides alerts/warnings for relating to flooding, power outages, wildfires, sandstorms, or the like. For example, alerts may be obtained via a wireless emergency alert (WEA) broadcast, via a subscription to a really simply syndication (RSS) feed, or the like. The alerts may include an alert type (e.g., smoke/fire, sandstorm, etc.), an alert area, an alert duration, etc. As such, the filter management system 180 may further utilize such information for determining the at least one filter action.

For example, air filter 185 may have a useful life that may be defined by one or more of: a volume of material captured by the air filter 185, e.g., a “coverage volume,” a volume of air filtered/processed via the air filter 185, and/or a passage of time since the air filter 185 was manufactured and/or since a package containing air filter 185 was opened. In one example, there may be different maximum coverage volumes that may be defined for different types of captured material. For instance, there may be a first maximum coverage volume for pet hair and dander, a second maximum coverage volume for PM 10, a third maximum coverage volume for mold types, and so forth. In one example, filter management system 180 may obtain current coverage volumes of air filter 185 for one or more types of materials and/or for the air filter 185 overall, e.g., via detection modules 181 and/or from the detection module(s) 186 of HVAC 183. In one example, filter management system 180 may also obtain and maintain past measures of coverage volume. Thus, in one example, filter management system 180 may also have stored trend data regarding the filter utilization of air filter 185, including measure(s) of coverage volume. In a similar manner, filter management system 180 may also obtain and store past measures of air flow/air volume processed via air filter (and/or on/off timing information of HVAC 183), from which air flow/air volume may be derived based upon the make, model, and configuration of HVAC 183.

In one example, using current filter utilization data (or current as well as historic filter utilization data) and environmental data (historic, current, and/or forecast), filter management system 180 may implement at least one forecasting model to predict/forecast functional condition/status of air filer 185 at a future time period. For instance, the functional condition may be defined by one or more objective criteria, such as an overall remaining unused coverage volume (or a used coverage volume), a remaining unused coverage volume for one or more types of materials/particles (or a used coverage volume for the one or more types of materials/particles), etc. In one example, air filter 185 may have a maximum expiration date, e.g., a date beyond which the air filter 185 should no longer be used, regardless of coverage volume, which may be incorporated as part of the objective criteria. In one example, the functional condition/status may be a percentage of useful life remaining (or consumed), a duration of time of useful life remaining (e.g., uninterrupted calendar days, months, etc., or a duration of time of actual, active use remaining), or the like. In one example, the functional condition/status may be on a binary scale/range or other scales/ranges, such as: (good, poor), (good, replace), (new, like new, average, fair, poor, expired), (0 to 10), (1 to 5), etc.

For instance, in accordance with the present disclosure, predicting air filter functional condition at a future time period may be in accordance with one or more machine learning algorithms (MLAs), e.g., one or more trained machine learning models (MLMs). For instance, a machine learning algorithm (MLA), or machine learning model (MLM) trained via a MLA may comprise a deep learning neural network, or deep neural network (DNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. For instance, a distance from a separation hyperplane of a binary classifier may be scaled to a percentage of remaining useful life or a likelihood of having a particular condition/status, e.g., of whether an air filter will or will not be in a “good” functional condition or a “poor”/“replace” functional condition at a given future time period for which the classifier provides such prediction.

In one example, a prediction of air filter functional condition at a future time period may be made using a time series prediction/forecasting model, e.g., based upon current and/or past/historic filter utilization information and past, current, and/or forecast environmental data as predictors, such as a moving average (MA) model, an autoregressive distributed lag (ADL) model, an autoregressive integrated moving average (ARIMA) model, a seasonal ARIMA (SARIMA) model, or the like. Similarly, other regression-based models may be trained and used for prediction, such as logistic regression, polynomial regression, ridge regression, lasso regression, etc. In one example, the present disclosure may predict/forecast future functional condition/status of an air filter at a given future time period using multiple factors as predictors (e.g., covariates, or exogenous factors). For instance, a seasonal auto-regressive integrated moving average with exogenous factors (SARIMAX) model may be used. Alternatively, a vector auto-regression (VAR), or VAR moving average (VARMA) model may be used. Similarly, a vector auto-regression moving-average with exogenous factors/regressors (VARMAX) model may be applied. In one example, an output between 0 and 1 may indicate a probability (e.g., a likelihood) of an air filter being in a “good” functional condition (or “poor” functional condition, e.g., non-functional/no remaining coverage volume, or the like) at a future time period. For instance, an output of 0.5 may indicate a 50% probability/likelihood of an air filter being in a good functional condition at the future time period. Alternatively, or in addition, an output of 0.5 may indicate a forecast/prediction of 50% useful remaining life. In still another example, a forecast remaining useful life may be scaled to the output of the model.

In one example, an MLM for predicting air filter functional condition at a future time period may comprise a recurrent neural network (RNN), a long-short term memory (LSTM) neural network, or the like. For instance, RNNs and LSTMs may be trained on and make predictions with respect to time series data. In another example, an MLM for predicting air filter functional condition at a future time period may comprise a convolutional neural network (CNN) that is suitable for time series data, such as an AlexNet or WaveNet. In accordance with the present disclosure, inputs/predictors for any or all of such prediction or forecasting models may include past and current coverage volume (or coverage volume by material/particle type), information on time on/time off and/or air volume processed via air filter 185, and historical, current, and/or forecast environmental data. In addition to smoke, PM, smog concentration, or the like, temperature data may be used as a prediction, which may be correlated with whether HVAC 183 has run (or may be forecast to run) and for how long, etc. (e.g., HVAC 183 may be predicted to run if the outside temperature is below 70 degrees Fahrenheit or above 78 degrees Fahrenheit, or the like). In one example, inputs/predictors may further include covariates, such as the type of HVAC 183, duct sizing, home/indoor space volume, user calendar/schedule information, (e.g., historic, such as whether and when a user is home/away (e.g., users 171A-171B) and/or whether and when a user is forecast to be away (e.g., based upon calendar/schedule items indicating that the user will be home or away), and so forth). It should be noted that for purposes of MLM training, the training data may be obtained with respect to various air filters, various air filtration systems, various users, and so forth. In various examples, the MLM(s) may be specific to particular users, families, building, vehicles, or the like. Similarly, in one example, MLM(s) may be specific to particular air filtration system types (e.g., particular makes/models), may be specific to different regions or areas, etc. For instance, the models may be specialized by selection of appropriate training data that is specific to the region/area, the make, model, and so forth.

Thus, filter management system 180 may apply these inputs to one or more prediction models to generate predictions/forecasts of a functional condition of air filter 185 at one or more future time periods. In addition, the filter management system 180 may determine the at least one filter action in accordance with one or more predictions for one or more future time periods. For example, if the air filter 185 is predicted to be in a “poor” condition, no useful life remaining, no remaining coverage volume, or the like, the at least one filter action may be to replace the air filter 185. If the air filter 185 is predicted to be at a “fair” condition, to have remaining coverage volume for three weeks and then no remaining coverage volume, or the like, the at least one filter action may include replacing the filter after three weeks passes. In one example, the at least one filter action may be based upon user calendar/schedule information (e.g., of user 171A and/or user 171B). For instance, where HVAC 183 and air filter 185 are deployed in a home and the user(s) 171A-171B is/are scheduled to be away for two months starting ten days from the present, the at least one filter action may be to replace the filter between the present time and a time that the user(s) 171A-171B is/are scheduled to depart home. It should be noted that in one example, the at least one forecasting/prediction model may already account for the expectation that the user(s) 171A-171B will be away for at least some of the time. For example, the usage of HVAC 183 may be less during the time the user(s) 171A-171B is/are away where historical data input to the prediction/forecasting model(s) indicate that thermostat 168 may typically be set to a lower heating temperature or higher cooling temperature when the home is unoccupied.

It should also be noted that in one example, the present disclosure may apply to mobile air filters and air filtration systems in mobile platforms, e.g., vehicles, or the like. For instance, FIG. 1 further depicts a vehicle 191, which may include a filtration system 192 and air filter 193, which may be installed therein. The vehicle 191 may include an on-board unit (OBU) equipped for cellular communications, for communications via an LTE sidelink, a 5G sidelink, or the like, for communications via a dedicated short range communication (DSRC) networks, via IEEE 802.11 and/or 802.15-based communications, and so forth. In one example, filtration system 192 may include one or more detection modules (not shown), which may be the same or similar to detection module(s) 186 of HVAC 183 and/or detection modules 181 of filter management system 180. In one example, filter management system 180 may perform the same or similar operations as described above in connection with air filter 185 and HVAC 183, but with respect to air filter 193 and filtration system 192. However, in such an example, filter management system 180 may further utilize calendar/schedule information (e.g., of user 171A and/or user 171B, who may be owners, lessees, or the like of vehicle 191) to identify where the vehicle 191 has been and/or is expected to be (and hence where the filtration system 192 and air filter 193 have been used and/or will be used). For instance, as noted above, filter management system 180 may utilize environmental data as input(s) to one or more forecasting/prediction models for predicting air filter functional condition/status at a future time period. In the example of a mobile air filter 193 in vehicle 191, filter management system 180 may thus gather and utilize environmental data from locations (e.g., areas, places, etc.) where the vehicle 191 has been and/or is expected to be (e.g., the vehicle having traveled through a sand storm, a dust storm, an ash storm resulting from a volcanic eruption, and the like).

To further illustrate, the forecasting/prediction models may learn which areas affect air filters more, and can predict the impact on air filter longevity based on vehicle locations or predicted locations (e.g., if driving in poor quality air in a congested city most of the time the air filter 193 may be forecast to have a shortened usable lifespan and the filter management system 180 may determine that the at least one filter changing action may comprise changing air filter 193 sooner). However, if vehicle 191 is expected to travel to a mountainous rural area in the near future with good air quality, then the usable life of air filter 193 may be extended. Thus, for instance, filter management system 180 may look at a user calendar, GPS location records of vehicle 191, etc., to identify that vehicle 191 has been in predominantly urban areas for one month, but will be travelling to the mountains for two week, or vice versa. As such, filter management system 180 may provide instructions to change air filter 193 before an extended trip, or can be extended to after a trip where a lower filter load may be expected (e.g., if the vehicle 191 is projected to not be in a city for the next three weeks, then the air filter 193 is not projected to go from 60% to 90% used, and the filter management system 180 may omit sending a replacement instruction to the user, or may send a replacement instruction to replace on or before a later date). Similarly, vehicle 191 may be traveling into an area that is predicted to have high pollen or particulates, or somewhere that is forecast to have low pollen or particulates, in response to which filter management system 180 can recommend replacing before or postponing until after the trip is completed depending on the particular circumstances.

Various other examples of a same or similar nature may be provided in accordance with the present disclosure, depending upon the air filtration system, the particular filter and its history of use, the forecast environmental conditions and/or the historic environmental conditions in an area, or areas, in which the air filter is used, the user's (or users') calendars/schedules, the user preferences (such as a typical heating or cooling temperature at which heating or air conditioning may be activated, and so forth). In addition, it should be understood that the system 100 may be implemented in a different form than that which is illustrated in FIG. 1, or may be expanded by including additional endpoint devices, access networks, network elements, application servers, etc. without altering the scope of the present disclosure. For example, communication network 110 is not limited to an IMS network, wireless access network 150 is not limited to a UMTS/UTRAN configuration, and so forth. Similarly, the present disclosure is not limited to an IP/MPLS network for VoIP telephony services, or any particular type of broadcast television network for providing television services. Various other configurations in accordance with the present disclosure are therefore possible. For instance, functions of device controller 190 may instead be performed by PC 166, e.g., without having a separate device controller. Likewise, home network 160 may include additional network-connected (e.g., IoT) devices, such as a stereo, wireless headphones, a humidistat, a fan, a window, curtains or blinds, a fireplace (e.g., an electric fireplace), an automated scent generator, and so forth.

In still another example, any functions described with respect to filter management system 180 may be performed by server 115 in communication network 110. In such case, devices in home network 160 (e.g., HVAC 183, mobile device 170A and/or mobile device 170B, or the like) may be configured to receive instructions from server 115. In one example, device controller 190 may receive instructions from filter management system 180 and/or server 115, and may distribute such instructions to appropriate devices within the home network 160. In such an example, the operator of communication network 110 may therefore provide an air filter management service, e.g., in addition to telecommunication and/other network connectivity services. In still another example, aspects described above in connection with filter management system 180 may alternatively or additionally be implemented by device controller 190, HVAC 183, filtration system 192, or the like. For instance, HVAC 183 may comprise a smart appliance that may monitor its own status and that of air filter 185, and that may further obtain environmental data from one or more external sources in order to then forecast/predict air filter functional condition at a future time period and to determine the at least one filter changing action accordingly. Thus, these and other modifications are all contemplated within the scope of the present disclosure.

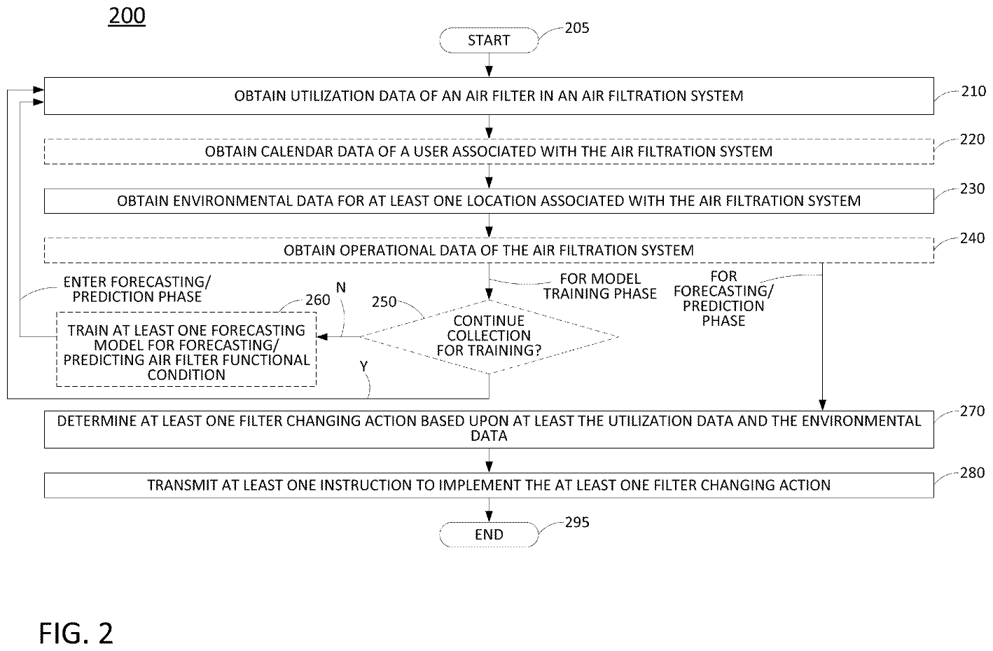

FIG. 2 illustrates a flowchart of an example method 200 for transmitting an instruction to implement a filter changing action based upon air filter utilization data and environmental data. In one example, the method 200 is performed by one or more components of the system 100 of FIG. 1, such as by filter management system 180, device controller 190, HVAC 183, server 115, or the like in FIG. 1, and/or any one or more components thereof (e.g., a processor, or processors, performing operations stored in and loaded from a memory), or by one or more of filter management system 180, device controller 190, HVAC 183, and/or server 115 in conjunction with one another and/or one or more other devices, such as mobile devices 170A-170B, vehicle 191, server(s) 189, and so forth. In one example, the steps, functions, or operations of method 200 may be performed by a computing device or system 300, and/or processor 302 as described in connection with FIG. 3 below. For instance, the computing device or system 300 may represent any one or more components of filter management system 180, device controller 190, HVAC 183, server 115, etc. in FIG. 1 that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system.

The method 200 begins at step 205 and proceeds to step 210. In step 210, the processing system obtains utilization data of an air filter in an air filtration system. For instance, as described above, the utilization data may include one or both of: time of use data (e.g., in calendar days and/or a time of active use of the air filtration system, or the like) or status data, such as an airflow measure, a coverage measure of materials trapped by the air filter, an identification of at least one material type of the materials trapped by the air filter, etc. To further illustrate, the at least one material type may be detected via one or more detection modules/sensors, such as a spectrometry module, a fluorescent probing module, a lipopolysaccharide detection module, a particulate sensor (e.g., laser scattering based or thermal electrical sensor), a volatile organic compound sensor, and so forth. In one example, the one or more detection modules may be part of the air filtration system or may be a separate unit with one or more modules for detecting one or more material types, e.g., deployed at a store where new filters can be purchased, or the like. In one example, one or more detection modules may comprise part of the processing system. Alternatively, or in addition, the utilization data may be obtained by the processing system from the air filtration system (such as an HVAC or component thereof, a vehicle air filtration system, etc.), from a device controller (e.g., a smart home/IoT device controller), or the like, which may report the utilization data to the processing system via wireless and/or wired communication over one or more networks, such as illustrated in the example of FIG. 1 and described above.

In optional step 220, the processing system may obtain calendar data (e.g., schedule information) of a user associated with the air filtration system. For instance, as described above, in one example, the air filter may be deployed in a mobile air filtration system, e.g., of a vehicle (which may include cars, buses, ships, trains, aerial vehicles such as planes and drones, trailers, containers or other portable structures, and so forth). As such, the location of the air filtration system over time may be relevant to determining the material load that has impacted the air filter or that may be forecast to impact the air filter (e.g., including the typical environmental conditions at such location(s), the actual observed/measure environmental conditions at such location(s), the forecast environmental conditions at such location(s), etc.). The calendar data may be obtained from a mobile device or PC of the user, from a network-based service to which the user subscribes, or the like via wireless and/or wired communication over one or more networks, such as illustrated in the example of FIG. 1 and described above.

In step 230, the processing system obtains environmental data for at least one location associated with the air filtration system. For instance, the environmental data may be obtained via wireless and/or wired communication over one or more networks, such as illustrated in the example of FIG. 1 and described above, from one or more environmental data sources, such as an environmental data feed (e.g., from one or more of server(s) 189 in FIG. 1), the air filtration system (which may be coupled to or in communication with one or more environmental sensors external to the building, vehicle, or the like in which the air filtration system and air filter are deployed), or an endpoint device of the user associated with the air filtration system (which may obtain the environmental data from an environmental data feed).

In accordance with the present disclosure, the environmental data may comprise historical environmental data and/or forecast environmental data. In this regard, it should be noted that as referred to herein “historical” may include current and/or most recently available measurements of a particular type of data. In one example, the environmental data may comprise air quality data. Thus, for example, the historical environmental data may comprise historical air quality measurements for the at least one location associated with the air filtration system. Similarly, forecast environmental data may comprise forecast air quality measurements for the at least one location. As noted above, in one example, the at least one location may be identified based upon the calendar data. For instance, where the air filtration system is a component of a vehicle, the at least one location may comprise at least one location frequented by the vehicle (e.g., via GPS data) or at least one location that the vehicle is anticipated to be present (e.g., based on calendar data of a user associated with the vehicle).

In optional step 240, the processing system may obtain at least one of: operational data of the air filter or operational data of the air filtration system. For instance, the operational data of the air filter may comprise: a filter size, a filter thickness, a filter medium, a filter efficiency class, etc. In one example, the air filter may have a barcode a quick response (QR) code, a radio frequency identification (RFID) tag, or the like, which may be scanned upon installation in the air filtration system and/or in connection with placement of the filter in an external analysis system. Accordingly, the processing system may perform a lookup based upon filter identification information indicated in the code, tag, or the like. Similarly, the operational data of the air filtration system may include a make, model, or the like of the air filtration system. Alternatively, or in addition, the operational data of the air filtration system may include one or more of: a maximum airflow resistance (and/or safe range), a measured airflow resistance, a nominal air processing speed (e.g., in cubic feet per minute (CFM) or the like), a duration of usage, at least one temperature setting associated with the air filtration system, at least one humidity setting associated with the air filtration system, a duct sizing, a volume of space protected by the air filtration system, and so forth. In one example, one or more of the foregoing may be maintained in a database or catalog via which the make, model, or other information about the air filter and/or the air filtration system may be used as a look-up.

In optional step 250, the processing system may determine whether to continue to collect data for training at least one forecasting model for forecasting/predicting air filter functional condition at a future time period. If answered in the affirmative, the method 200 may return to step 210. For instance, the processing system may continue to collect any or all of such types of data for a defined period of time and/or until a threshold quantity of data is collected. If answered in the negative, the method 200 may proceed to optional step 260 (e.g., the threshold duration of time and/or quantity of data may be collected after a number of repetitions of any or all of steps 210-240).

At optional step 260, the processing system may train (or retrain) the at least one forecasting model, e.g., as described above, to forecast/predict air filter functional condition at a future time period based upon one or more input factors such as: historical air filter utilization data, historical and/or forecast environmental data, air filtration system operational data, and/or user calendar/schedule data, or the like. For example, the at least one forecasting model may comprise a time series prediction model that may predict/forecast an air filter functional condition at a future time period, e.g., based at least in part upon past functional condition (e.g., material coverage, etc.) and environmental data (and in some examples, further in accordance with calendar/schedule data and/or air filtration system operational data). In another example, the at least one forecasting model may comprise a distance-based binary classifier, which may determine a score that comprises or corresponds to remaining usable life (or time past the end of usable life), a material load, or the like, e.g., a distance from a separation hyperplane. Similarly, in one example, the at least one forecasting model may comprise one or more other types of AI/ML models such as a DNN, a GAN, a decision tree algorithm/model, such as a GBDT or the like, and so forth. It should be noted that at least some of the data may be used for labels for the training. For instance, the at least one forecasting model may be trained by making predictions for later time periods based upon preceding data, and identifying the accuracy of such predictions based upon the actual measured/obtained data from the time period for which the forecast/prediction is made. As noted above, the forecasting model(s) may be particularized to an area/region, an air filtration system type, the building, vehicle, or the like, the user or organization associated with the air filter and the air filtration system, and so forth.

Following optional step 260, the method 200 may enter a forecasting/prediction phase and may return to step 210. Thus, for example, a repetition of any or all of steps 210-240 may be for gathering data relevant to making a prediction of air filter condition at a future time period (and/or for identifying a current state/condition of the air filter). In one example, data may be gathered and stored over successive time periods, e.g., such that the processing system possesses historical utilization data of the air filter, historical environmental data, and so forth.

In step 270, the processing system determines at least one filter changing action based upon at least the utilization data and the environmental data. In various examples, the at least one filter changing action may be determined further based upon the calendar/schedule data that may be obtained at optional step 220 and/or based upon the at least one of: the operational data of the air filter or the operational data of the air filtration system that may be obtained at optional step 240. In one example, step 270 may include applying data from any of steps 210-240 to the at least one forecasting model, e.g., to obtain a prediction of the air filter's functional condition at one or more future time periods. Alternatively, or in addition, step 270 may include rule-based analysis of data from any of steps 210-240 to identify a current condition/state of the air filter. For instance, as noted above, step 210 may include measuring a material load on the air filter via one or more detection modules/sensors, such as a spectrometry module, a fluorescent probing module, a lipopolysaccharide detection module, a particulate sensor (e.g., laser scattering based or thermal electrical sensor), a volatile organic compound sensor, and so forth.

Notably, while a time series of such data (as well as environmental data) may be useful to forecast future operational condition of the air filter, the current/most recent measurements may directly indicate that the air filter is in a condition to replace. Similarly, the current/most recent measurements may indicate that the air filter is in a “poor” condition, but still useable condition (e.g., according to one or more objective criteria, such as a coverage volume of trapped materials of one or more types). In a rule-based scenario, the processing system may be configured to apply a rule that indicates that the air filter has two months of usable life left when in a “poor” condition. In one example, an environmental forecast may then be used in connection with a second rule that may adjust the two month time period up or down. For instance, if there is a forecast of smoke, smog, dust storm, etc., if the area is prone to one or more of such conditions with a designated probability within the two month time window, or the like, then the remaining usable life may be reduced. However, if there is no forecast of smoke, smog, dust storm, etc., if the area is not prone to such conditions e.g., with very low probability, such as less than 5% likelihood within the next two months, less than 2% likelihood in the next two months, etc., then the time period may be extended beyond two months. In any case, the at least one filter changing action may comprise replacing or cleaning the air filter at a selected time, e.g., where the selected time may be current, or may be later depending on the forecast environmental data, forecast usage, and/or forecast travel of the user(s), and so forth.

In an example relating to a mobile air filtration system (e.g., in a vehicle or the like), step 270 may include referencing a user's calendar/schedule to determine that the air filter is to be changed before an extended trip, or pushed to after the trip is completed where a lower filter load may be expected (e.g., if the vehicle is projected to be away from a city for the next three weeks, the processing system 180 may determine that the filter is to be replaced on or before a later date). Similarly, a vehicle may be anticipated to be going into an area that is predicted to have very high pollen or particulates, or somewhere that is low pollen or particulates, in response to which the processing system can determine to replace the air filter before or postpone until after the trip is completed depending on the particular circumstances. In one example, the at least one filter changing action may comprise replacing the air filter with a new filter of a second filter type that is different from a first filter type of the filter (e.g., different thickness, different MERV rating, HEPA vs. non-HEPA, one that is designed for enhanced performance for allergens vs. pathogens vs. particulate, etc.). For instance, the different quality of air filter may comprise an air filter having a designated association with a particular type of forecast air quality condition for the recommended time period e.g., for location(s) associated with the air filtration system. For instance, there may be times of detected or forecast wildfire smoke, volcanic ash, dust storms, high pollen, smog, etc. with corresponding filters that may be more effective to address one or more of such conditions.

In step 280, the processing system transmits at least one instruction to implement the at least one filter changing action. For example, the at least one instruction may be transmitted via wireless and/or wired communication over one or more networks to one or more of: the air filtration system, a device controller associated with the air filtration system, a vehicle (e.g., an OBU thereof), a user's mobile device, and so forth. For instance, the air filtration system may display a particular light and/or a particular light color, may display a message on a display screen of the air filtration system, or the like which may indicate that the air filter is to be replaced or cleaned (e.g., presently or at a designated future time period). In an example in which the at least one filter changing action may comprise replacing the air filter with a new filter of a second filter type, the at least one instruction may identify the second filter type and the light, light color, and/or message to be presented on the display screen for indicating the second filter type. Similarly, a push notification may be caused to appear on the user's mobile device, such as via an in-app push notification for an IoT device management application, an air filtration system management application, or the like, via a text message and/or email notification, and so forth. In an example in which the processing system comprises the air filtration system, the at least one instruction may be to a display component of the processing system/air filtration system, e.g., to present a visual indicator as described above. Following step 280, the method 200 proceeds to step 295 where the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 210-250, steps 210-280, and so forth. For instance, the method 200 may continue to be performed, in whole or in part, on an ongoing basis. In this regard, it should be noted that in one example, the method 200 may continue to gather air filter utilization data, environmental data, etc. on an ongoing basis and may return to a training phase to retrain the at least one forecasting model and/or to train one or more new forecasting models, which may occur in parallel to determining filter changing actions and transmitting instructions pertaining to a same filter, a replacement filter, one or more filters for one or more other air filtration systems, and so forth. In one example, optional step 240 may follow optional step 250 or may precede optional step 210. For instance, in one example the air filtration system operational data may comprise static data such that it does not need to be collected on a repetitive basis. In one example, step 280 may include transmitting an instruction to a filter manufacturer, vendor, or the like to initiate mailing/delivery of a new air filter, e.g., to the user and/or to a premises of the air filtration system. For instance, if the at least one filter changing action is to replace the air filter in three weeks, the processing system may transmit an order and delivery instruction/request for a new filter to be delivered on or before such date. In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for transmitting an instruction to implement a filter changing action based upon air filter utilization data and environmental data, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for transmitting an instruction to implement a filter changing action based upon air filter utilization data and environmental data (e.g., a software program comprising computer-executable instructions) can be loaded into memory 304 and executed by hardware processor element 302 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for transmitting an instruction to implement a filter changing action based upon air filter utilization data and environmental data (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor, utilization data of an air filter in an air filtration system;
obtaining, by the processing system, environmental data for at least one location associated with the air filtration system;
determining, by the processing system, at least one filter changing action based upon at least the utilization data and the environmental data; and
transmitting, by the processing system, at least one instruction to implement the at least one filter changing action.

2. The method of claim 1, wherein the utilization data comprises at least one of:
time of use data; or
status data.

3. The method of claim 2, wherein the status data comprises:
an airflow measure;
a coverage measure of materials trapped by the air filter; or
an identification of at least one material type of the materials trapped by the air filter.

4. The method of claim 3, wherein the at least one material type is detected via at least one of:
a spectrometry module;
a fluorescent probing module;
a lipopolysaccharide detection module;
a particulate sensor; or
a volatile organic compound sensor.

5. The method of claim 1, wherein the environmental data comprises air quality data.

6. The method of claim 1, wherein the environmental data comprises at least one of:
historical environmental data; or
forecast environmental data.

7. The method of claim 1, wherein the environmental data is obtained from at least one of:
an environmental data feed;
the air filtration system; or
an endpoint device of a user associated with the air filtration system.

8. The method of claim 1, further comprising:
obtaining calendar data of a user associated with the air filtration system, wherein the at least one location is identified based upon the calendar data.

9. The method of claim 1, wherein the air filtration system is a component of a vehicle.

10. The method of claim 9, wherein the at least one location associated with the air filtration system comprises at least one of:
at least one location frequented by the vehicle; or
at least one location that the vehicle is anticipated to be present.

11. The method of claim 1, further comprising:
obtaining at least one of: operational data of the air filter or operational data of the air filtration system, wherein the at least one filter changing action is determined further based upon the at least one of: the operational data of the air filter or the operational data of the air filtration system.

12. The method of claim 11, wherein the operational data of the air filtration system comprises at least one of:
a maximum airflow resistance;
a measured airflow resistance;
a duration of usage;
at least one temperature setting associated with the air filtration system; or
at least one humidity setting associated with the air filtration system.

13. The method of claim 11, wherein the operational data of the air filter comprises at least one of:
a filter size;
a filter thickness;
a filter medium; or
a filter efficiency class.

14. The method of claim 1, wherein the at least one filter changing action comprises:
replacing the air filter with a new filter at a selected time.

15. The method of claim 14, wherein the at least one filter changing action comprises:
replacing the air filter with a new filter of a second filter type that is different from a first filter type of the filter, wherein the at least one instruction identifies the second filter type.

16. The method of claim 1, wherein the at least one filter changing action comprises:
replacing the air filter with a different air filter for a recommended time period and reinstalling the air filter in the air filtration system at an end of the recommended time period.

17. The method of claim 16, wherein the different air filter comprises an air filter having a designated association with a particular type of forecast air quality condition for the recommended time period.

18. The method of claim 1, wherein the at least one filter changing action is determined in accordance with an output of at least one forecasting model, wherein the at least one forecasting model provides at least one output comprising a prediction of an air filter functional condition at a future time period.

19. A non-transitory computer-readable medium storing instructions which, when executed by a processing system including at least one processor, cause the processing system to perform operations, the operations comprising:
obtaining utilization data of an air filter in an air filtration system;]
obtaining environmental data for at least one location associated with the air filtration system;
determining at least one filter changing action based upon at least the utilization data and the environmental data; and
transmitting at least one instruction to implement the at least one filter changing action.

20. A device comprising:
a processing system including at least one processor; and
a non-transitory computer-readable medium storing instructions which, when executed by the processing system, cause the processing system to perform operations, the operations comprising:
obtaining utilization data of an air filter in an air filtration system;]
obtaining environmental data for at least one location associated with the air filtration system;
determining at least one filter changing action based upon at least the utilization data and the environmental data; and
transmitting at least one instruction to implement the at least one filter changing action.
